(19) United States
(12) Patent Application Publication
(10) Pub. No.: US 2007/0269713 A1
(43) Pub. Date: Nov. 22, 2007

(54) BATTERY RETAINER FOR A GOLF CAR

(75) Inventors: Donald S. Hanson, Augusta, GA (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,422

(22) Filed: May 19, 2006

(51) Int. Cl. H01M 2/10; B60R 16/04

(52) U.S. Cl. 429/99; 429/100; 180/68.5

(57) ABSTRACT

A battery hold-down assembly is provided including a retaining member and a fastener member. The retaining member can have a body with first and second surfaces generally connected by a sidewall. The second surface can include a dividing member generally extending therefrom. The dividing member can have a width generally less than the width of the second surface. The second surface can be configured to abut a top of a battery and the divider can be configured to extend between adjacent batteries. The retaining member can include at least one aperture passing therethrough. The fastener member can have a first end passing through the aperture at the first surface and a second end passing through the aperture at the second surface.

### FIELD

The present teachings relate to golf cars and more specifically to battery trays for golf cars.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many battery-powered golf cars are equipped with battery tray assemblies including battery trays and battery retaining members coupled to a frame of the golf car. These battery tray assemblies are often made of metals prone to corrosion. As such, these battery trays often require painting for protection.

### SUMMARY

According to the present disclosure, a battery hold-down assembly is provided including a retaining member and a fastener member. The retaining member can have a body with first and second surfaces generally connected by a sidewall. The second surface can include a dividing member generally extending therefrom. The dividing member can have a width generally less than the width of the second surface. The second surface can be configured to abut a top of a battery and the divider can be configured to extend between adjacent batteries. The retaining member can include at least one aperture passing therethrough. The fastener member can have a first end passing through the aperture at the first surface and a second end passing through the aperture at the second surface.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a perspective view of a golf car including the battery tray assembly of the present teachings;

FIG. 2 is a perspective view of the battery tray assembly of the present teachings coupled to the golf car frame;

FIG. 3 is an exploded perspective view of the battery tray assembly shown in FIG. 2;

FIG. 4 is a rear perspective view of the battery tray shown in FIG. 2;

FIG. 5 is a front perspective view of the battery tray shown in FIG. 2;

FIG. 6 is a bottom perspective view of the battery tray shown in FIG. 2;

FIG. 7 is a perspective view of the battery tray retainer shown in FIG. 2;

FIG. 8 is a bottom perspective view of the battery tray retainer shown in FIG. 2; and

FIG. 9 is a sectional view of the battery tray assembly shown in FIG. 2.

### DETAILED DESCRIPTION OF THE VARIOUS EMBODIMENTS

The following description of various embodiments is merely exemplary in nature and is in no way intended to limit the present teachings, application, or uses.

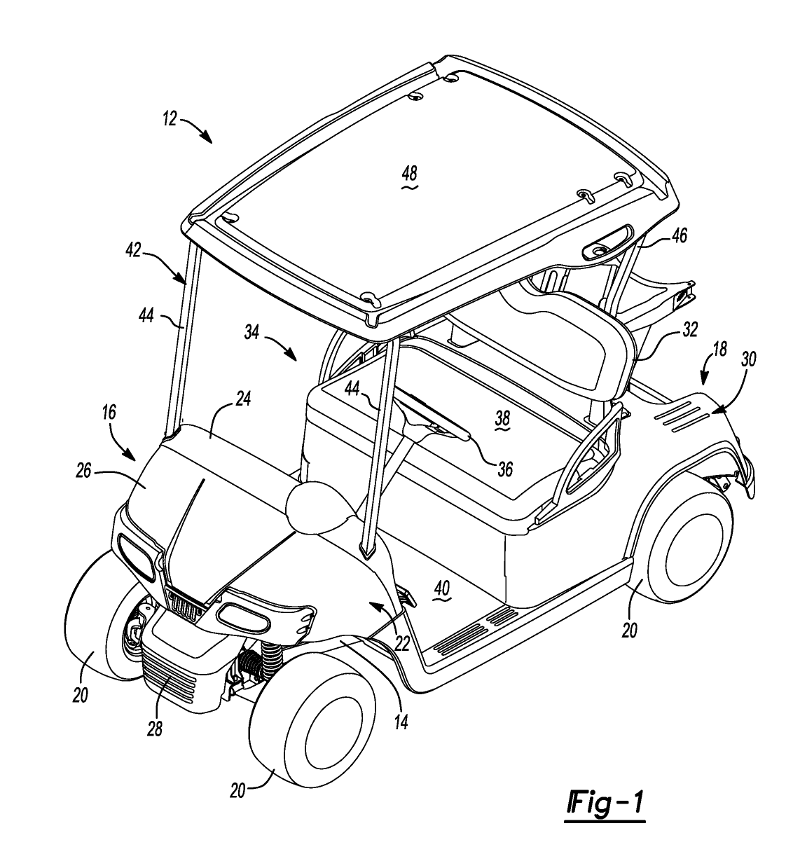

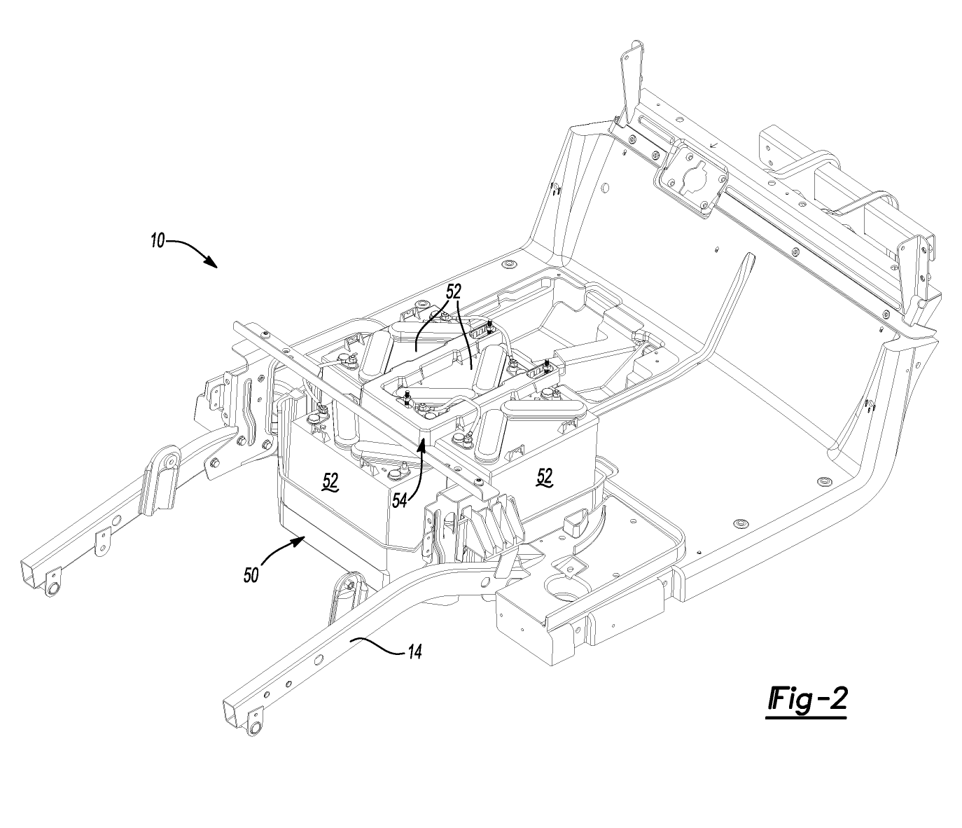

With initial reference to FIGS. 1 and 2, a battery tray assembly constructed in accordance to the present disclosure is shown and identified generally at reference numeral 10. The battery tray assembly 10 is illustrated operably connected to an exemplary golf car 12. It is appreciated that the golf car 12 is merely exemplary and that the battery tray assembly 10 can be adapted for use with other golf car configurations. Furthermore, the battery tray assembly 10 described herein is not limited for use with golf cars and can also be used with other vehicles such as, but not limited to, utility vehicles, lawnmowers, and other turf care vehicles.

The golf car 12 can include a frame 14 having a front portion 16 and a rear portion 18 mounted thereon. The golf car 12 can further include wheels 20 drivingly coupled to the frame 14.

The front portion 16 of golf car 12 can include a front body assembly 22 having an instrument panel 24, a front cowl 26, and a bumper 28. The rear portion 18 can include a rear body assembly 30 having a golf bag storage area 32 and a passenger seating area 34. The passenger seating area 34 can include a steering wheel 36, accelerator and brake pedals (not shown), a seat 38, and a floor portion 40.

The golf car 12 can further include a strut assembly 42. The strut assembly 42 can include a pair of front struts 44 and a pair of rear struts 46 supporting a roof canopy 48. The pair of front struts 44 can extend between the front portion 16 of the golf car 12 and the roof canopy 48 and the pair of rear struts 46 can extend between the rear portion 18 of the golf car 12 and the roof canopy 48.

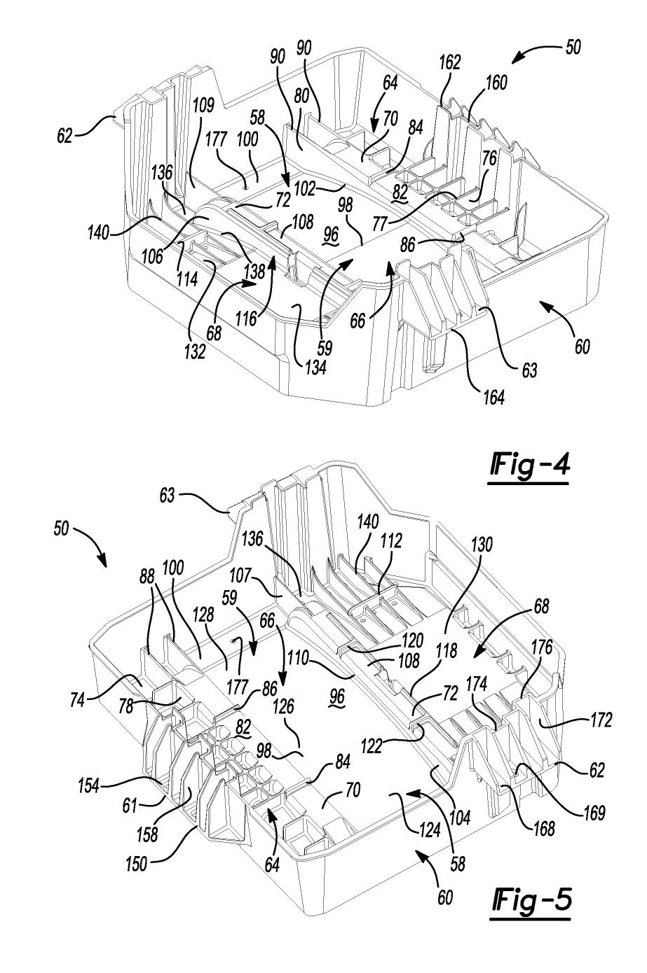

As seen in FIGS. 2-9, golf car 12 can include a battery tray assembly 10. The battery tray assembly 10 can include a battery tray 50, batteries 52, and a battery hold-down assembly 54. As best shown in FIGS. 4 and 5, the battery tray 50 can include an integrally formed body 56 having a floor 58, sidewall 60, and arms 61, 62, 63. Battery tray 50 can be formed from a plastic such as a long fiber plastic available from Composite Products, Inc. of Winona, Minn.

With particular reference to FIGS. 4, 5, and 6, battery tray floor 58 can include inner and outer portions 59, 65. Inner portion 59 can include a front portion 64, a center portion 66, and a rear portion 68. Front portion 64 and center portion 66 can be divided by a first wall member 70. Center portion 66 and rear portion 68 can be divided by a second wall member 72.

Front portion 64 can include a generally planar floor surface 74 having ribs 76, 77 extending therefrom. Ribs 76 can extend between sidewall 60 and first wall member 70 in a direction generally from front to rear and ribs 77 can extend between ribs 76. Ribs 76, 77 can have a height generally equal to the height of first wall member 70. Therefore, batteries 52 can rest on ribs 76, 77 and first wall member 70.

First wall member 70 can include sidewalls 78, 80 and upper surface 82. Sidewall 78 can extend between upper surface 82 and planar floor surface 74. Sidewall 80 can extend between upper surface 82 and center portion 66. Upper surface 82 can support batteries 52 thereon. Upper surface 82 can also include dividers 84, 86 extending from sidewall 78 to sidewall 80 to maintain separation between batteries 52. Dividers 84, 86 can be spaced apart from one another and sidewall 60 a distance generally equal to the width of a battery 52. A series of ribs 88, 90 can connect first wall member 70 to sidewall 60 and have a height generally equal to the height of first wall member 70.

Center portion 66 can include a convex floor 96. Convex floor 96 can include a highest point 98 at a central location within center portion 66 and lower points 100 near sidewall 60, resulting in sidewall 80 having a convex lower portion 102.

Second wall member 72 can include sidewalls 104, 106 and upper surface 108. Sidewall 104 can extend between upper surface 108 and convex floor 96, creating a convex lower portion 110 to sidewall 104. Sidewall 106 can extend between upper surface 108 and rear portion 68. A series of ribs 107, 109 can connect second wall member 72 to sidewall 60 and have a height generally equal to the height of second wall member 72. Rear portion 68 can include dividers 112, 114, 116.

Dividers 112, 114 can generally extend in a direction from sidewall 104 to sidewall 106 and be located between divider 116 and sidewall 60. Dividers 112, 114 can be spaced apart a distance generally equal to the length of a battery 52. Divider 116 can include a first portion 118 generally extending parallel to sidewalls 104, 106 and second and third portions 120, 122 extending generally perpendicular from first portion 118 and in a direction toward front portion 64.

First and second portions 120, 122 can be spaced apart from one another and sidewall 60 a distance generally equal to the width of a battery 52 and can be generally in line with dividers 86, 84, respectively. First portion 118 can be spaced apart from sidewall 60 at front portion 64 a distance generally equal to the length of a battery 52. First portion 118 can be spaced apart from sidewall 60 at rear portion a distance generally equal to the width of a battery 52. Dividers 84, 86, 112, 114, 116 can therefore define four battery locations 124, 126, 128, 130.

Rear portion 68 can include a convex floor 132. Convex floor 132 can include a highest point 134 at a central location within rear portion 68 and lower points 136 near sidewall 60, resulting in sidewall 106 having a convex lower portion 138. Ribs 140 can extend between battery tray sidewalls 60. Ribs 140 can have a height generally equal to the height of upper surface 108, thereby creating a seating surface for battery 52.

Battery tray outer portion 65 can include a surface that generally conforms with inner portion 59. However, convex floors 96, 132 appear concave when viewed from outer portion 65. Additionally, outer portion 65 can include ribs 142, 144, 146 in concave portion 148. Rib 142 can extend along concave portion 148 between battery tray sidewall 60. Ribs 144, 146 can extend generally perpendicular to rib 142 generally between sidewalls 104, 106.

Sidewall 60 can generally extend around floor 58 and have arms 61, 62, 63 extending outwardly therefrom. Arm 61 can be located near front portion 64. Arm 61 can include an engagement portion 150 generally extending perpendicular from sidewall 60. The engagement portion 150 can include a generally flat upper and lower surfaces 154, 156 with a pair of mounting apertures 153 therethrough. Ribs 158 can extend between upper surface 154 and sidewall 60. Sidewall 60 can include a series of vertically extending ribs 160 and recesses 162 at engagement portion 150, as best shown in FIG. 4.

Arms 62, 63 can be located near rear portion 68 and can be generally similar to one another. Therefore, only arm 63 will be discussed for simplicity, with the understanding that arm 62 is similar. Arm 63 can include an engagement portion 164 generally extending perpendicular from sidewall 60. The engagement portion can include a generally planar body 166 having upper and lower surfaces 168, 170 with a mounting aperture 169 therethrough. A series of ribs 172 can extend between upper surface 168 and sidewall 60. Sidewall 60 can include vertically extending ribs 174 and recesses 176 at engagement portion 164, as best shown in FIG. 5.

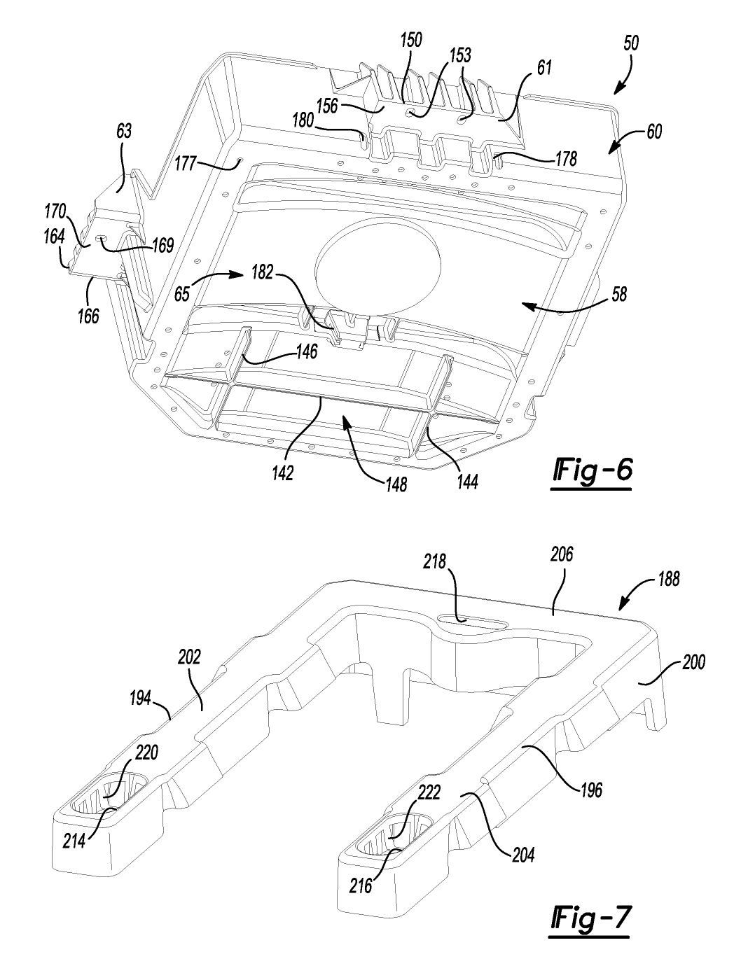

Battery tray 50 can further include drain apertures 177 in floor 58. Battery tray 50 can also include apertures 178, 180, 182 (FIG. 6) for coupling battery hold-down assembly 54 thereto. Apertures 178, 180 can be located in sidewall 60 near floor 58 at front portion 64. Aperture 182 can be located in second wall member 72 adjacent sidewall 104.

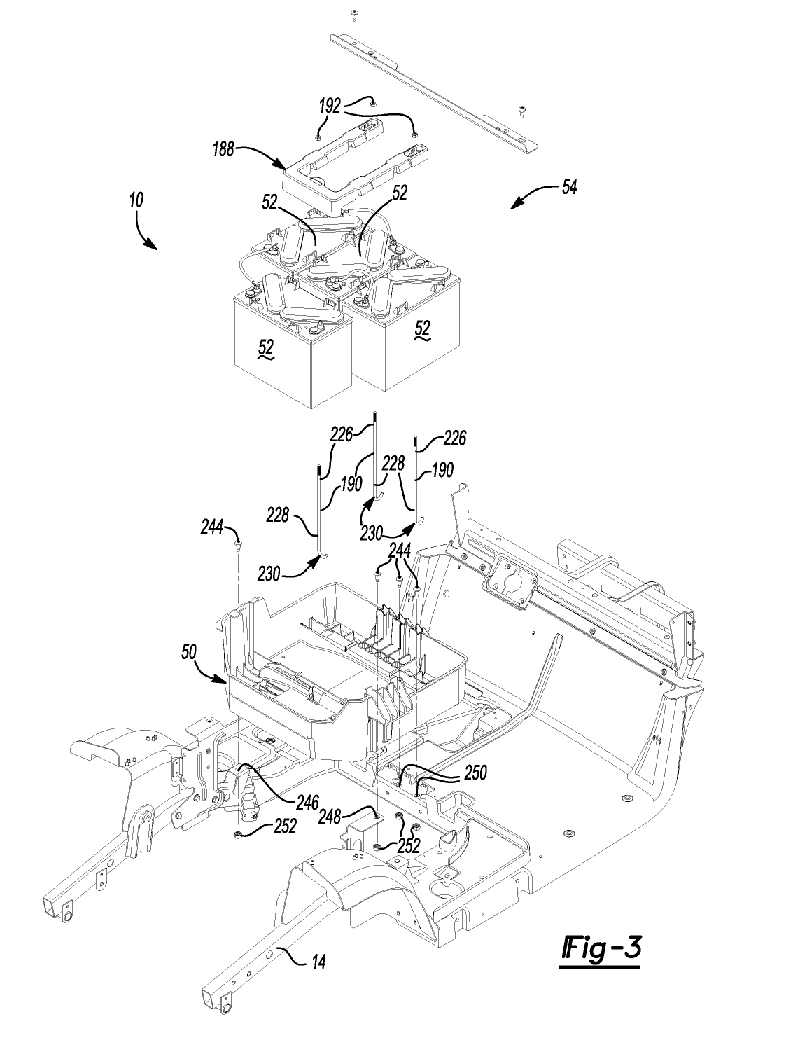

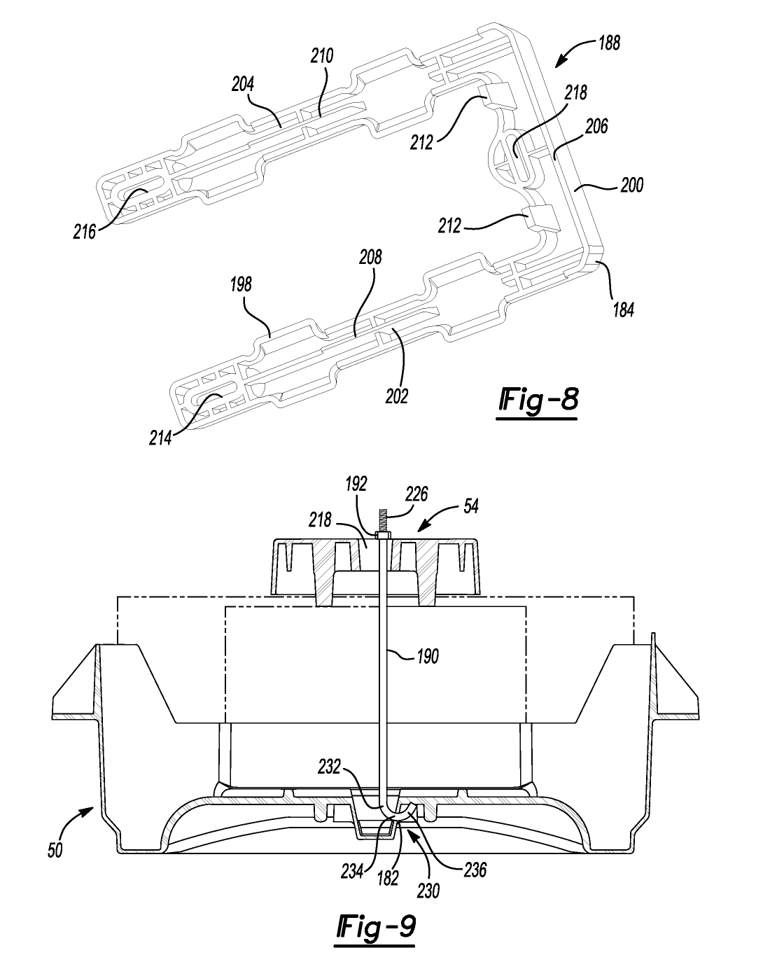

With particular reference to FIGS. 3, 7, and 8, battery hold-down assembly 54 can include a retaining member 188, fastener members 190, and nuts 192. As shown in FIGS. 7 and 8, retaining member 188 can include a body 194 having upper and lower surfaces 196, 198 and a sidewall 200. Body 194 can be generally U-shaped having first and second legs 202, 204 and base 206 extending between first and second legs 202, 204.

Legs 202, 204 can include dividing members 208, 210 extending from lower surface 198. The distance between dividing members 208, 210 can be generally equal to the width of a battery 52. Base 206 can also include dividers 212 extending therefrom. Dividers 212 can extend from lower surface 198.

Apertures 214, 216 can be located in first and second legs 202, 204 and aperture 218 can be located in base 206. Apertures 214, 216, 218 can generally be in the form of elongated slots. Apertures 214, 216 can be surrounded by recessed portions 220, 222, as shown in FIG. 7. Recessed portions 220, 222 can have a width greater than or equal to the diameter of nut 192. Apertures 214, 216, 218 can have a width generally less than the diameter of nuts 192.

Fastener member 190 can be a metal rod having a first end 226 that is generally straight and a second end 228 that includes a hooked portion 230. First end 226 can be threaded for engagement with nut 192. Hooked portion 230 can include a first portion 232, a second portion 234, and a third portion 236.

With particular reference to FIGS. 2 and 9, battery tray assembly 10 will now be described in an assembled state. Four batteries 52 can be located in battery locations 124, 126, 128, 130. Retaining member 188 can be located on top of batteries 52 with dividers 208, 210, 212 disposed therebetween and generally aligned with dividers 84, 86, 112, 114, 116. For simplicity, fastener 190 will be described with reference to aperture 218 with the understanding that similar attachment applies to fastener members 190 at apertures 214, 216 as well.

The third portion 236 of hooked portion 230 can pass through aperture 182 and generally extend outside of battery tray 50. First portion 232 can be located inside of battery tray 50 on an opposite side of sidewall 60 from third portion 236. Second portion 234 can generally abut a portion of sidewall 60 at aperture 132. First end 226 of fastener member 190 can extend through aperture 218 and nut 192 can be threaded thereon. Nut 192 can generally engage upper surface 196 and urge second portion 234 against sidewall 60, thereby capturing battery 52 between retaining member 188 and battery tray 50.

Battery tray assembly 10 can be mounted to frame 14 at arms 61, 62, 63. Arms 61, 62, 63 can abut flange portions 238, 240, 242 extending from frame 14. Fasteners 244 can pass through arm apertures 153, 169 and frame flange apertures 246, 248, 250. Nuts 252 can be threaded onto fasteners 244, thereby coupling battery tray assembly 10 to frame 14.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A battery hold-down assembly for use in retaining a plurality of batteries comprising:
a retaining member having a body with first and second surfaces generally connected by a sidewall, said second surface including a plurality of dividing members generally extending therefrom, said plurality of dividing members having a width generally less than a width of said second surface, said second surface configured to abut a top of a plurality of batteries and said plurality of dividers configured to extend between adjacent ones of said plurality of batteries, said retaining member including at least one aperture passing therethrough; and
a fastener member having a first end passing through said aperture at said first surface and a second end passing through said aperture at said second surface.

2. The battery hold-down assembly of claim 1, wherein said retaining member is comprised of a plastic.

3. The battery hold-down assembly of claim 1, wherein said second end of said fastener member includes a hooked portion.

4. The battery hold-down assembly of claim 1, wherein said first end of said fastener member includes a threaded portion.

5. The battery hold-down assembly of claim 4, further comprising a nut, said nut engaged with said threaded portion of said fastener member and generally abutting said first surface of said retaining member body.

6. The battery hold-down assembly of claim 1, wherein said aperture is a slot.

7. The battery hold-down assembly of claim 1, wherein said retaining member body is generally U-shaped.

8. A battery tray assembly comprising:
a battery tray;
a plurality of batteries disposed in said battery tray;
a retaining member having a body with first and second surfaces generally connected by a sidewall, said second surface including a dividing member generally extending therefrom, said dividing member having a width generally less than a width of said second surface, said second surface configured to abut a top of each of said plurality of batteries and said divider configured to extend between adjacent batteries, said retaining member including at least one aperture passing therethrough; and
a fastener member having a first end passing through said aperture at said first surface and generally engaged therewith and a second end passing through said aperture at said second surface, said second end coupled to said battery tray.

9. The battery tray assembly of claim 8, wherein said second end of said fastener member includes a hook portion.

10. The battery tray assembly of claim 9, wherein said battery tray includes a wall portion having first and second sides and an aperture near said wall portion having said second end of said fastener member passing therethrough, a first portion of said hook portion being on said first side of said wall portion and a second portion of said hook portion being on a second side of said wall portion, a third portion of said hook portion connecting said first and second portions and disposed generally below and generally abutting a bottom of said wall portion.

11. The battery tray assembly of claim 8, wherein said first end of said fastener member includes a threaded portion.

12. The battery tray assembly of claim 11, further comprising a nut engaged with said threaded portion of said fastener member and abutting said first surface of said retaining member, resulting in said engagement between said fastener portion first end and said first surface.

13. The battery tray assembly of claim 9, wherein said retaining member body is generally U-shaped.

14. A vehicle comprising:
a frame; and
a battery tray assembly including a battery tray coupled to said frame, a plurality of batteries disposed in said battery tray, a retaining member, and a fastener member, said retaining member having a body with first and second surfaces generally connected by a sidewall, said second surface including a dividing member generally extending therefrom, said dividing member having a width generally less than a width of said second surface, said second surface configured to abut a top of each of said plurality of batteries and said divider configured to extend between adjacent batteries, said retaining member including at least one aperture passing therethrough, said fastener member having a first end passing through said aperture at said first surface and generally engaged therewith and a second end passing through said aperture at said second surface, said second end coupled to said battery tray.

15. The vehicle of claim 14, wherein each of said plurality of batteries includes a lower surface generally abutting said battery tray and an upper surface generally abutting said second surface of said retaining member, said retaining member and said battery tray thereby capturing said battery therebetween.

16. The vehicle of claim 14, wherein said second end of said fastener member includes a hook portion.

17. The vehicle of claim 16, wherein said battery tray includes a wall portion having first and second sides and an aperture near said wall portion having said second end of said fastener member passing therethrough, a first portion of said hook portion being on said first side of said wall portion and a second portion of said hook portion being on a second side of said wall portion, a third portion of said hook portion connecting said first and second portions and disposed generally below and generally abutting a bottom of said wall portion.

18. The vehicle of claim 14, wherein said first end of said fastener member includes a threaded portion.

19. The vehicle of claim 18, further comprising a nut engaged with said threaded portion of said fastener member and abutting said first surface of said retaining member, resulting in said engagement between said fastener portion first end and said first surface.

20. The vehicle of claim 14, wherein said vehicle is a golf car.
